(19) United States
(12) Patent Application Publication
(10) Pub. No.: US 2005/0112965 A1
(43) Pub. Date: May 26, 2005

(54) Resilient and colored bath sponge

(76) Inventor: Jone Chang, Taipei (TW)

Correspondence Address: BIRCH STEWART KOLASCH & BIRCH, PO BOX 747, FALLS CHURCH, VA, 22040-0747, US

(21) Appl. No.: 10/716,631

(22) Filed: Nov. 20, 2003

(51) Int. Cl. B32B 27/04; B32B 5/18; B32B 27/12; B32B 3/26; D03D 9/00

(52) U.S. Cl. 442/30; 442/43; 442/46; 442/49; 442/104; 442/105; 428/304.4; 428/318.4

(57) ABSTRACT

A resilient and colored bath sponge mainly aims at improving color control and the color layer peeling problems occurring in conventional bath sponges. The layer is made by blending a pigment during the blowing process or spraying a water-soluble pigment on the exterior of the finished product. The bath sponge of the invention is a mesh structure consisting of sponge fibers. Each of the sponge fibers includes a foam body and a resilient and colored resin layer covering the foam body. The resin layer can generate a smooth feeling to touch, is aesthetically appealing and reinforces the sponge fibers.

### FIELD OF THE INVENTION

The present invention relates to a resilient and colored bath sponge and particularly to a bath sponge that has a sponge structure covered by a resilient and colored resin layer formed by spray or immersion coating after completion of the foaming process.

### BACKGROUND OF THE INVENTION

It is a common bathing experience for many people that merely using bathing soap or cream cannot thoroughly remove dirt from the body, especially the aging cuticles on the skin. Bathing tools help to rejuvenate skin. Moreover, the skin of the human body usually has grease secretion that interacts with the cleaning agent and obstructs the desired foam and bubbles. Bathing tools that include a mesh structure can generate finer foams and bubbles, thus enabling the cleaning agent to be more effective cleaning the skin.

Present bathing tools are generally divided into mesh type bath scrubbers and air permeable bath sponges. Bath sponges include a coarse pore structure and a fine pore structure. They are usually fabricated by blowing and forming. Taking into account air permeability, reduction of residual contamination after bathing, and enhancement of the skin massage effect to improve blood circulation in the blood capillary of the skin, bath sponges with coarse pore structures are more desirable. However, bath sponges with coarse pore structures have larger pores between sponge fibers. As a result, the bath sponge is easily torn and ruptured caused by the poor resilience of the sponge fiber and stretch and deformation of the bath sponge. When tension and stress increase, the mesh structure is easily damages.

Furthermore, in order to enhance visual appeal and versatility to motivate the consumer's desire to purchase, bath sponges are fabricated in many different styles and shapes during the blowing process. To embody the bath sponge with various colors is another design focus. Present methods for coloring the bath sponge generally include the following two approaches:
1. Adding a water-soluble pigment to the blowing material: the water-soluble pigment and the blowing material are mixed before the blowing process, the mixed material is then blown and formed to become colored, finished products. Due to factors such as blowing time and temperature, the color of the finished product is difficult to control. Hence, color variations often occur between finished products. While this approach costs less, it results in a lower quality production yield, thus it is not widely adopted.
2. Coloring the exterior of the finished product by spraying: as shown in FIG. 1, a layer of water-soluble pigment is sprayed on the outer surface of the blown bath sponge. This approach can coat a desired color onto the same surface of the finished product to enhance visual appeal; however, the water-soluble pigment cannot fully cover the sponge fibers of the blown sponge. As a result, there is still color variation between the outer surface and inner portion of the sponge. The quality of the finished products is degraded. Moreover, when the water-soluble pigment is dried and in contact with the cleaning agent during bathing and scrubbing, it easily peels off. Hence, its' color maintains for a short period. Therefore, it is also not desirable.

### SUMMARY OF THE INVENTION

The primary object of the present invention is to resolve the aforesaid disadvantages. The invention provides a bath sponge that has stronger sponge fibers that are easier to control during the coloring process to obtain an even color. After the bath sponge is blown and formed, a resin layer containing a water-soluble pigment coats the foam body. Thus, it can provide the following effects:
1. The resin layer is resilient. It enhances the extendibility of the sponge fibers and reduces the risk of tear and rupture when subjected to stretching and deformation. Therefore, the sponge structure is stronger.
2. The water-soluble pigment is contained in the resin layer and does not easily fade away. Moreover, the resin layer completely covers the foam body. Thus, there is no color variation between the inner side and outer side.
3. The resin layer provides a friction interface for the sponge fibers. Thus, coupled with the cleaning agent enhances the cleaning effect and removes cuticles from the skin during bathing.

The foregoing, as well as additional objects, features and advantages of the invention will be more readily apparent from the following detailed description, which precedes with references to the accompanying drawings.

### BRIEF DESCRIPTION OF THE DRAWINGS

FIG. 1 is a schematic view of a conventional bath sponge.

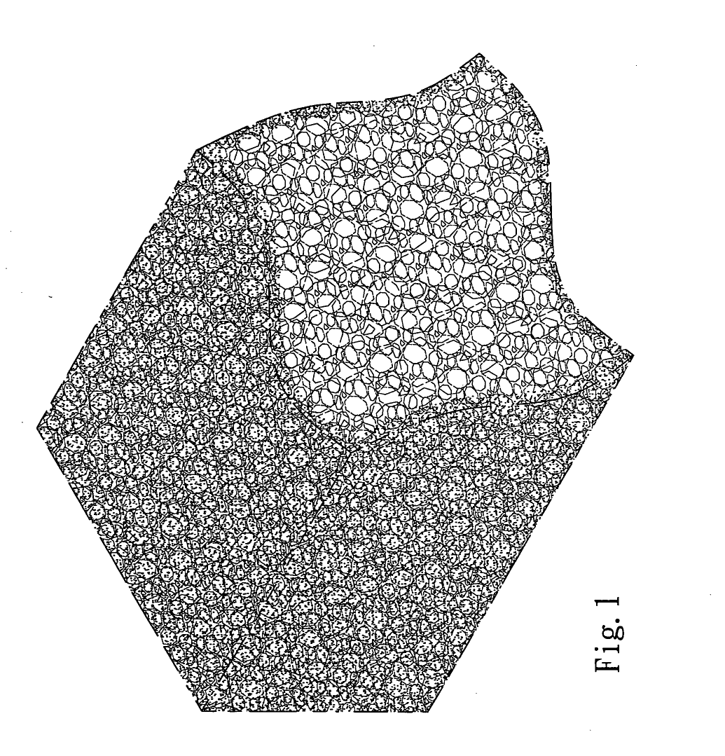

FIG. 2 is a perspective view of the present invention.

FIG. 3 is a sectional view of the present invention.

FIG. 4 is a sectional view of a sponge fiber according to the invention.

### DETAILED DESCRIPTION OF THE PREFERRED EMBODIMENT

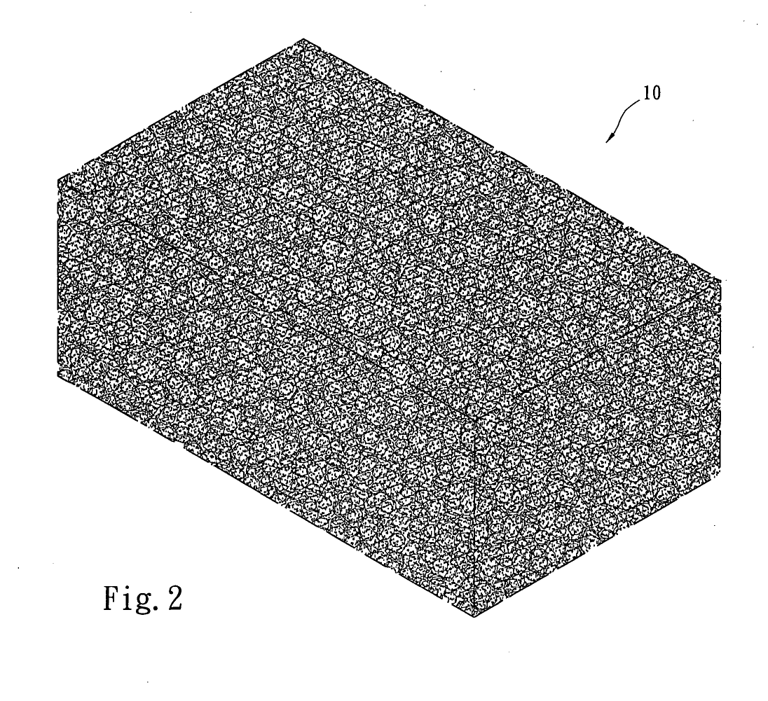

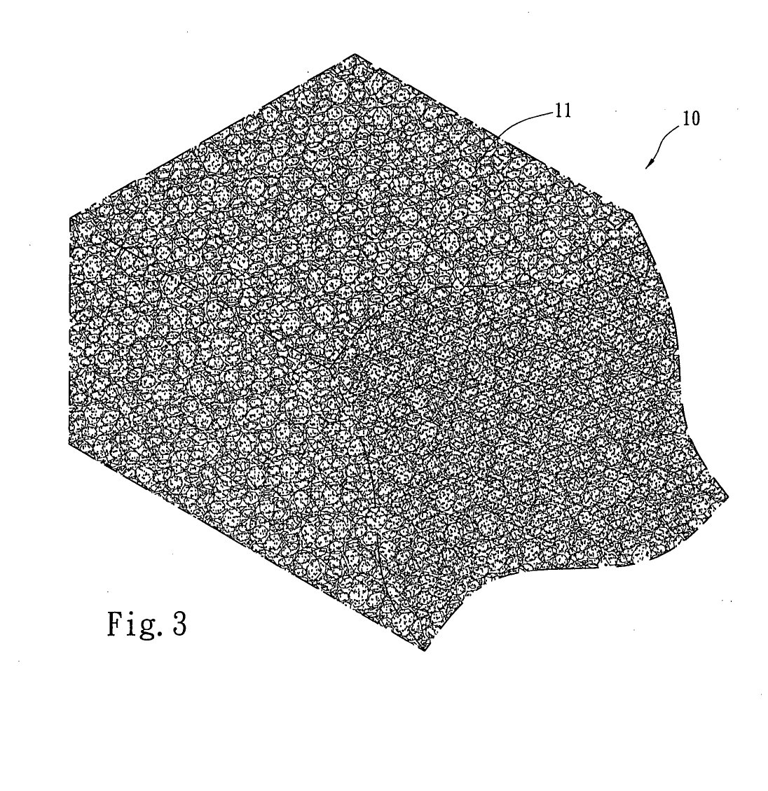

Please referring to FIGS. 2, 3 and 4, a bath sponge 10 according to the invention consists of sponge fibers 11, which form a mesh structure. Each of the sponge fibers 11 includes a foam body 12 and a resilient, colored a resin layer 13 covering the foam body 12.

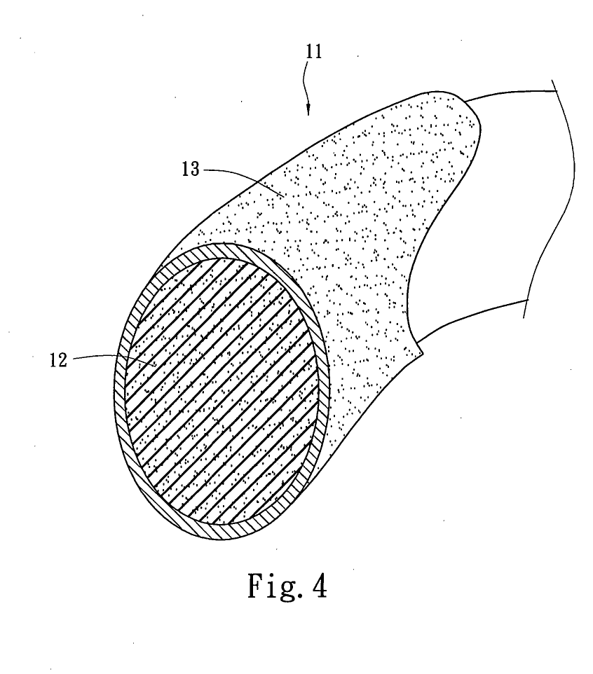

In order to enable the resin layer 13 to cover the foam body 12, the bath sponge 10 to enhance the massage effect, to improve blood circulation and boost skin rejuvenation. The sponge fibers 11 are formed in a mesh structure from filaments made from a substance with high density, high specific weight. The mesh structure has coarse pores without a foam membrane. The resin layer 13 is made from a polymer polyethylene acrylic resin. For fabricating the bath sponge of the invention, the resin layer 13 covers the sponge fibers 11 by spraying or immersion. As the resin layer 13 is also water-soluble, and the sponge fibers 11 form a mesh structure with coarse pores, the resin layer 13 may pass through the mesh structure without clogging. After drying and bonding, as shown in FIG. 4, the resin layer 13 completely covers the foam body 12. The color of the resin layer 13 is better controlled.

During bathing, the bath sponge 10 of the invention, due to the resin layer 13 has an improved extendibility and resilience. When subject to stretch and deformation rupturing of the sponge fibers 11 has less effect. Hence, durability of the bath sponge 10 increases. Moreover, the resin layer 13 provides an improved friction surface for the bath sponge 10 that generates a smoother feeling on the human skin. Thus, users not only can use the bath sponge 10 to remove the aged cuticles and dirt from the skin, they can also use it to produce a massage effect to rejuvenate skin cells.

While the preferred embodiment of the invention has been set forth for the purpose of disclosure, modifications of the disclosed embodiment of the invention as well as other embodiments thereof may occur to those skilled in the art. Accordingly, the appended claims intend to cover all embodiments that do not depart from the spirit and scope of the invention.

1. A resilient and colored bath sponge comprising woven sponge fibers;
wherein said sponge fibers are formed in a mesh structure, each of said sponge fibers includes a foam body and a resilient and colored resin layer covering said foam body.

2. The resilient and colored bath sponge according to claim 1, wherein said resin layer, constructed from a polymer polyethylene acrylic resin contains a water-soluble pigment.

3. The resilient and colored bath sponge according to claim 1, wherein said resin layer covers the sponge fibers by spraying.

4. The resilient and colored bath sponge according to claim 1, wherein said resin layer covers said sponge fibers by immersion.

5. The resilient and colored bath sponge according to claim 1, wherein said sponge fibers are a mesh structure made from filaments from a substance with high density having coarse pores without a foam membrane.
